(19) United States
(12) Patent Application Publication
(10) Pub. No.: US 2007/0046064 A1
(43) Pub. Date: Mar. 1, 2007

(54) Multi-sheet barrier panel for automobile door assemblies

(76) Inventor: Jay Winborn, Berkley, MI (US)

Correspondence Address: BUTZEL LONG, 350 SOUTH MAIN STREET, SUITE 300, ANN ARBOR, MI, 48104, US

(21) Appl. No.: 11/214,483

(22) Filed: Aug. 29, 2005

(51) Int. Cl. B60J 5/00

(52) U.S. Cl. 296/146.7

(57) ABSTRACT

Multi-sheet barrier panels for a motor vehicle door assembly that comprises two or more sheets that are attached together at discrete contact areas where depressions or projections molded into one sheet contacts an adjacent sheet. The space between adjacent sheets can be hollow or provided with an acoustic and/or thermal insulation material.

### TECHNICAL FIELD

The present invention relates to vehicle door assemblies which include water shield barriers that prevent the ingress of water, dust and air into vehicle passenger compartments and provide acoustic and thermal insulation for vehicle door assemblies. More particularly, the present invention relates to multi-sheet barrier panels for vehicle door assemblies which are configured to provide acoustic and thermal insulation for vehicle door assemblies.

### BACKGROUND ART

Automobile door assemblies generally include a door panel to which an inner trim panel is joined. The door panel includes a cavity within which the door window may be lowered. This cavity may also contain window regulating equipment, door locks, sound speakers, air bag systems, and the like. The inner trim panel is typically a rigid or semi-rigid panel formed of a cloth-like or plastic trim material which serves as the interior passenger compartment panel.

Door assemblies are susceptible to the ingress of water which can enter into door cavities through the openings through which the door windows slide. Holes are generally formed in the bottom of door assemblies to allow any water that enters the door cavities to drain out. However, as water enters door cavities and runs down toward the drain holes, it can seep into and through the inner trim panels unless a barrier of some type is provided in the assembly.

In order to protect inner trim panels from becoming wet and possibly stained or otherwise damaged, it is common to attach panel liners over door panels beneath inner trim panels. Such panel liners are often made of a treated paper material or can comprise a thin plastic film. The panel liners function to deflect any water entering door cavities so that the water runs down the liners to the bottoms of the door cavities without contacting the inner trim panels.

It is also known to provide vehicle door assemblies with insulation panels between the door panels and inner trim panels and in some cases incorporate the insulation panels with the interior trim panels. U.S. Pat. No. 5,345,720 to Illbruck, et al., U.S. Pat. No. 5,456,513 to Schmidt, U.S. Pat. No. 6,197,403 to Brown et al., U.S. Pat. No. 6,412,852 to Koa et al., U.S. Pat. No. 6,619,724 to Blomeling et al., U.S. Pat. No. 6,669,265 to Tilton et al., U.S. Pat. No. 6,676,195 to Marriott et al., U.S. Pat. No. 6,726,980 to Staelgraeve et al., U.S. Pat. No. 6,814,382 to Kohara et al, and U.S. Pat. No. 6,890,018 to Koa et al. and U.S. Published Patent Application Nos. 2003/0001408 to Hockenberry et al., 2003/0091806 to Staelgraeve et al., 2003/0164624 to Kohara et al., 2004/0113455 to Schmidt, 2004/0201246 to Miyahara et al., 2005/0052051 to Kohara et al, and 2005/0073171 to Koa et al. all are directed to vehicle door assemblies that include various insulation panels or elements.

The present invention provides multi-sheet barrier panels for vehicle door assemblies which function as water barriers and are configured to provide acoustic and thermal insulation for vehicle door assemblies.

### DISCLOSURE OF THE INVENTION

According to various features, characteristics and embodiments of the present invention which will become apparent as the description thereof proceeds, the present invention provides a barrier liner for a vehicle door assembly having a door panel and an inner trim panel, the barrier liner includes:

at least two sheet members, including a first and second sheet which have opposing surfaces that are spaced apart from each other; and

discrete attachment areas at which the first and second sheet are attached to one another, the discrete attachment areas including side walls that extent between the first and second sheets, the discrete attachment areas extending across a central portion of the barrier liner.

The present invention further provides a method of making a multi-sheet barrier panel for a vehicle door assembly having a door panel and an inner trim panel, the method involving:

providing least two sheet members, including a first and second sheet;

forming discrete depressions in at least one of the first and second sheet, the discrete depressions have bottoms;

superimposing the first and second sheets together so that the bottoms of the discrete depressions formed in one of the first and second sheets contacts the other of the first and second sheets at discrete contact areas; and

attaching the first and second sheets together at the discrete contact areas.

### BRIEF DESCRIPTION OF DRAWINGS

The present invention will be described with reference to the attached drawings which are given as non-limiting examples only, in which:

FIG. 1A is an elevational view of a multi-sheet barrier panel according to one embodiment of the present invention.

FIG. 1B is a cross-sectional view of the multi-sheet barrier panel of FIG. 1A taken along sectional lines II-II.

FIG. 1C is an enlarged view of the encircled portion “C” of the door assembly illustrated in FIG. 1B.

FIG. 1D is an enlarged view of the encircled portion “D” of the door assembly illustrated in FIG. 1B.

FIG. 2A is an elevational view of a multi-sheet barrier panel according to another embodiment of the present invention.

FIG. 2B is a cross-sectional view of the multi-sheet barrier panel of FIG. 2A taken along sectional lines II-II.

FIG. 3A is an elevational view of a multi-sheet barrier panel according to another embodiment of the present invention.

FIG. 3B is a cross-sectional view of the multi-sheet barrier panel of FIG. 3A taken along sectional lines II-II.

FIG. 3C is an enlarged view of the encircled portion “C” of the door assembly illustrated in FIG. 3B.

FIG. 3D is an enlarged view of the encircled portion “D” of the door assembly illustrated in FIG. 3B.

FIG. 4A is an elevational view of a multi-sheet barrier panel according to another embodiment of the present invention.

FIG. 4B is a cross-sectional view of the multi-sheet barrier panel of FIG. 4A taken along sectional lines II-II.

FIG. 4C is an enlarged view of the encircled portion “C” of the door assembly illustrated in FIG. 4B.

FIG. 4D is an enlarged view of the encircled portion “D” of the door assembly illustrated in FIG. 4B.

### BEST MODE FOR CARRYING OUT THE INVENTION

The present invention is directed to multi-sheet barrier panels for vehicle door assemblies which function as water barriers and are configured to provide acoustic and thermal insulation for vehicle door assemblies. The multi-sheet barrier panels of the present invention are configured to be received between an inner trim panel and a door panel of a door assembly. According to one embodiment, the multi-sheet barrier panels are made from two or more sheets of moldable material(s) that are configured and assembled together to produce discrete chambers which provide acoustic and/or thermal insulation barriers. The discrete chambers can be arrayed in numerous patterns and fashions across the multi-sheet barrier panels and between the two or more sheets of moldable material(s). The discrete chambers can be hollow or can contain acoustic and/or thermal insulation materials such as noise absorbing materials or materials with low thermal conductivity.

According to another embodiment of the present invention, the multi-sheet barrier panels are made from two or more sheets of moldable material(s) that are configured and assembled together to produce discrete areas at which the two or more sheets are attached together. In this embodiment, the two or more sheets are spaced apart except at the discrete attachment areas so as to provide a chamber(s) between the sheets which functions as an acoustic and/or thermal insulation barrier. The space or chamber(s) between the individual sheets of the multi-sheet barrier panels of this embodiment can contain acoustic and/or thermal insulation materials such as noise absorbing materials or materials with low thermal conductivity. The acoustic and/or thermal insulation materials can fill the entire space or chamber(s) between the individual sheets of the multi-sheet barrier panels or otherwise be provided in discrete locations between the sheets.

The individual sheets of the multi-sheet barrier panels can be made from a variety of moldable materials such as polyethylene, polystyrene, abs plastics, polypropylene, thermal plastics, foamable plastics, etc. The individual sheets can be separately molded by any suitable process such as vacuum molding, injection molding, extruding, etc. and then assembled together. Alternatively, the individual sheets can be molded simultaneously and fused together while still hot from a molding step. Virtually any means can be used to assembly the individual sheets together including, but not limited to, thermal welding, ultrasonic welding, chemical adhesives, mechanical fasteners, engaging or interlocking structures formed on or in the sheets, etc.

The multi-sheet barrier panels of the present invention can be configured to be attached to an exterior vehicle door panel using conventional fastening means such as commonly used “christmas tree” fasteners, or the like. Alternatively, the multi-sheet barrier panels of the present invention can include engagement structures that are configured to align and secure the multi-sheet barrier panels directly to exterior vehicle door panels. The use of such engaging structures avoids positioning the multi-sheet barrier panels between the inner trim panels and exterior door panels with mechanical fasteners such as screws, clips, push-in fasteners, etc. extending through each of the inner trim panel, the multi-sheet barrier panels and the exterior door panels. According to further embodiments of the present invention, the multi-sheet barrier panels can be attached to the interior trim panel of a door assembly.

In addition the use of engaging structures or mechanical fasteners, when the multi-sheet barrier panels are assembled in a door assembly, a conventional bead of sealant/adhesive material can be provided at the periphery of the multi-sheet barrier panels (between the multi-sheet barrier panels and the exterior door panel) to ensure that water does not contact the interior trim panel. Alternatively, the periphery of the outboard surface of multi-sheet barrier panels could be provided with a compressible sealing element that can be molded into the outboard surface of the outer most sheet of the multi-sheet assembly.

When the multi-sheet barrier panels are provided with engaging structures for aligning and securing the multi-sheet barrier panels directly to exterior vehicle door panels, the engaging structures can be molded into multi-sheet barrier panels when they are fabricated and can comprise hollow, solid or semi-hollow structures. Alternatively, the engaging structures can be made separately from the multi-sheet barrier panels and attached or fixed thereto by adhesives, thermal or ultrasonic welding, mechanical fasteners, cooperating engaging structures, etc.

In general the engaging structures are arranged and aligned on the outboard surface of the multi-sheet barrier panels so that the engaging structures collectively engage a cutout or a plurality of cutouts provided in the inboard surface of an exterior door panel.

The engaging structures help apply pressure between the multi-sheet barrier panels and the exterior door panels which has the effect of pressing the bead of sealant/adhesive material therebetween so as to ensure the production of a good moisture proof seal.

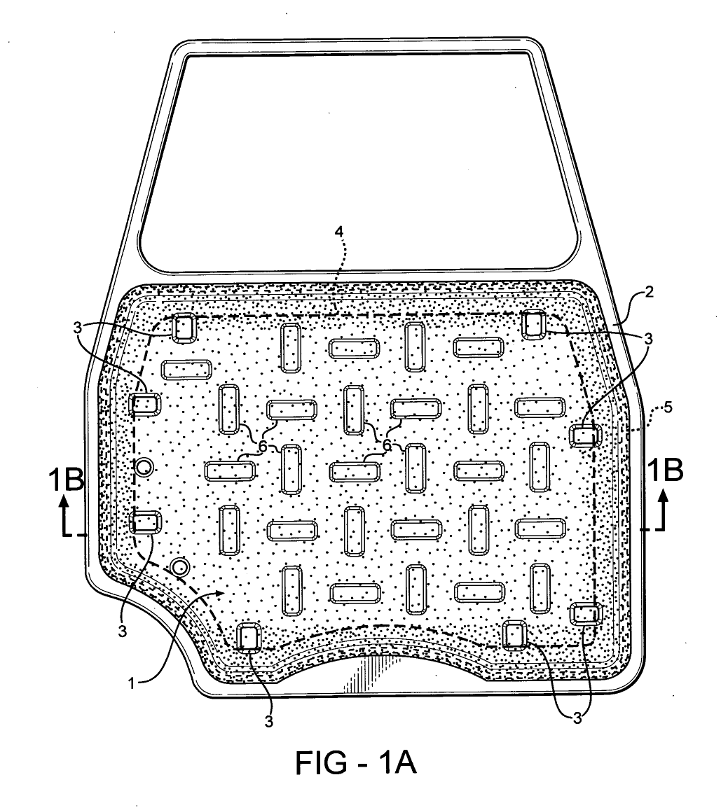

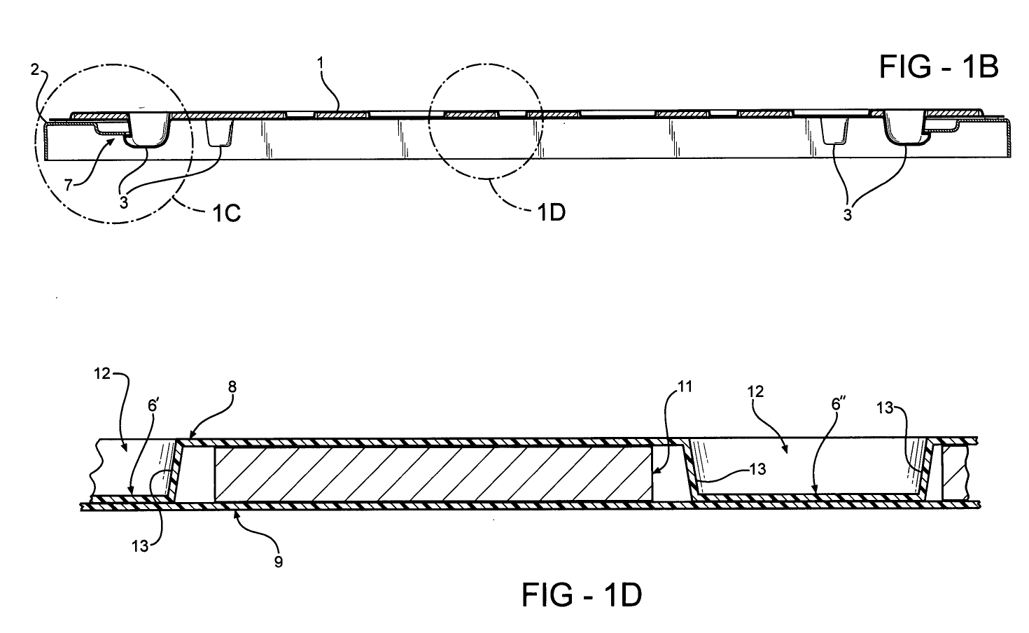

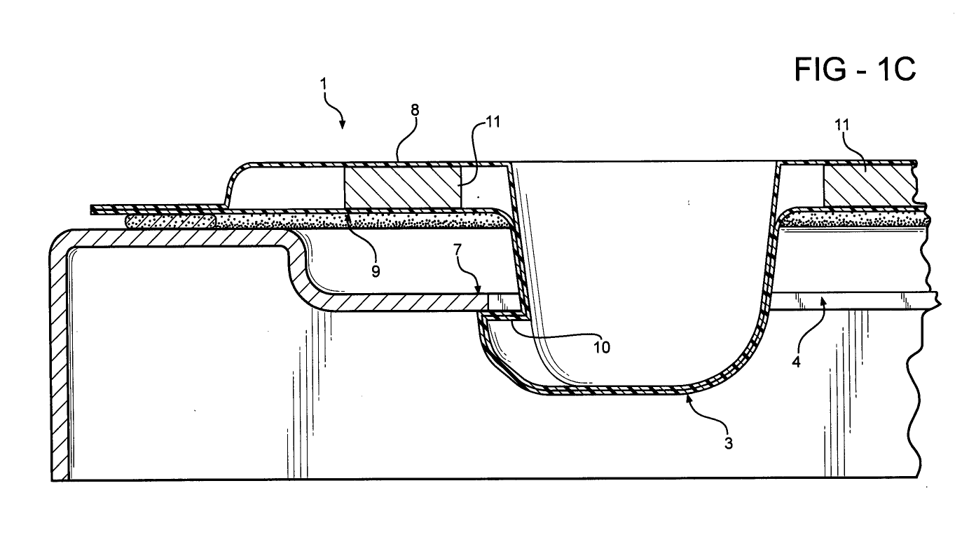

FIG. 1A is an elevational view of a multi-sheet barrier panel according to one embodiment of the present invention. The multi-sheet barrier panel is generally identified by reference numeral 1 and is depicted as being attached to an exterior door panel 2. The multi-sheet barrier panel 1 includes a plurality of engaging structures 3 that are spaced apart around the exterior edges of the multi-sheet barrier panel 1. As shown in broken lines, the exterior door panel 2 includes an opening 4 into which the engaging structures 3 are received so as to align the multi-sheet barrier panel 1 with the exterior door panel 2 and secure the multi-sheet barrier panel 1 to the exterior door panel 2. Also shown in broken lines is a sealing element 5 that extends along the periphery of the multi-sheet barrier panel 1 so as to be positioned between the multi-sheet barrier panel 1 and the exterior door panel 2. The sealing element 5 can comprises any conventional sealant/adhesive material applied as a bead on the multi-sheet barrier panel 1 or a compressible sealing element that can be molded into the outboard surface of the outer most sheet of the multi-sheet assembly.

The multi-sheet barrier panel 1 is provided with a plurality of discrete attachment areas 6 at which the separate sheets of the multi-sheet barrier panel 1 are attached to one another. In the embodiment of the invention shown in FIGS. 1A-1D, the discrete attachment areas 6 are alternatively aligned perpendicular to one another. As discussed in more detail below, the individual sheets of the multi-sheet barrier panel 1 are spaced apart from one another except at the discrete attachment areas 6 so that a space or chamber is provided between the individual sheets. This space or chamber can be hollow or can contain or be filled with acoustic and/or thermal insulation materials such as noise absorbing materials or materials with low thermal conductivity. It is to be understood that the discrete attachment areas 6 can have virtually any configuration and alignment and are not limited to the illustrative embodiments shown in the figures. For example, the discrete attachment areas 6 could comprise discrete or continuous linear or non-linear channels that are intersecting or non-intersecting.

FIG. 1B is a cross-sectional view of FIG. 1A taken along sectional lines II-II. FIG. 1B best shows the manner in which the engaging structures 3 extend into the opening 4 provide in the inboard side of the exterior door panel 2 so as to engage the edge 7 of the opening 4. As can be understood from FIGS. 1A and 1B the number and alignment of the engaging structures 3 can be varied as desired to accommodate a given door assembly, taking into consideration size, shape, etc. From the cross-sectional view the discrete attachment areas 6 formed in the multi-sheet barrier panel 1 are seen as providing structures (side walls) that strengthen the overall structure of the multi-sheet barrier panels 1.

FIG. 1C is an enlarged view of the encircled portion “C” of the door assembly illustrated in FIG. 1B. As can be seen best in FIG. 1C, the multi-sheet barrier panel 1 comprises two sheets, including an outer sheet 8 and an inner sheet 9. In general, the outer sheet 8 and inner sheet 9 are spaced apart from one another, except at the discrete attachment areas 6 and where the engagement structures 3 are formed. As shown in FIG. 1C, the engagement structure 6 includes a molded under-cut or overhanging edge 10 (shown upside down) that engages the peripheral edge 7 of the opening 4 formed in the exterior door panel 2. Having the engagement structures 3 formed by each of the inner and outer sheet 9, 8 as shown in FIG. 1C adds strength to the engagement structure 3. FIG. 1C depicts acoustic and/or thermal insulation materials, referred herein generally as insulating material 11, such as noise absorbing materials or materials with low thermal conductivity that are provided between the inner and outer sheets 9, 8. As discussed above, the insulating material 11 can be provided at discrete locations between the inner and outer sheets 9, 8 or completely throughout the space or chamber(s) formed between the inner and out sheets 9, 8. The insulating material can comprise any suitable material that provides for acoustic and/or thermal insulation including, but not limited to, thermoplastic polymers and elastomers, including polyethylene, polypropylene, polybutenes, polyisoprene and their copolymers. These materials can be functionalized according to known manners by, for example, controlling their densities, cellular structures and/or incorporating fillers to improve their acoustic and/or thermal insulating properties. For purposes of the present invention, polyethylene therephthalate, and Thinsulate™ acoustic insulation were determined to generally suitable for use as insulation materials.

In FIG. 1C the outer sheet 8 is shown as not being coextensive with the inner sheet 9 which extends outward over sealant/adhesive bead 5 to compress the same. In alternative embodiments, the outer sheet 8 and inner sheet 9 can be coextensive. In either configuration, the common perimeter of the outer sheet 8 and inner sheet 9 is fused or otherwise sealed together to increase the insulation properties and structural strength of the multi-sheet barrier panels.

FIG. 1D is an enlarged view of the encircled portion “D” of the door assembly illustrated in FIG. 1B. FIG. 1D depicts two adjacent attachment areas 6′ and 6″ between which the inner and outer sheets 9, 8 are spaced apart and contain an insulating material 11. FIG. 1D depicts the inner and outer sheets 9, 8 as being fused together at the discrete attachment areas 6′, 6″. Such fusion can be accomplished by pressing the inner and outer sheets 9, 8 together while they are partially molten or by applying both pressure and heat to the inner and outer sheets 9. 8 at the discrete attachment areas 6′, 6′. As noted above, in alternative embodiments the inner and outer sheets 9, 8 could also be attached together using adhesives, thermal or ultrasonic welding, mechanical fasteners, cooperating engaging structures, etc. As shown, the inner sheet 9 is relatively flat and the outer sheet 8 has depressions 12 formed therein which correspond to the discrete attachment areas 6. The side walls 13 of the depressions 12 add to the structural strength of the overall assembly.

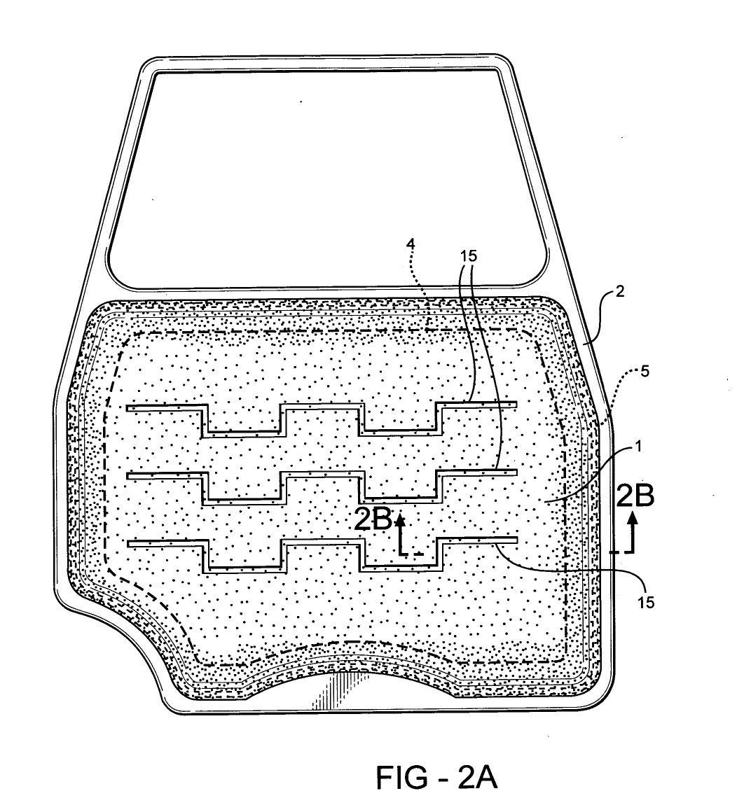

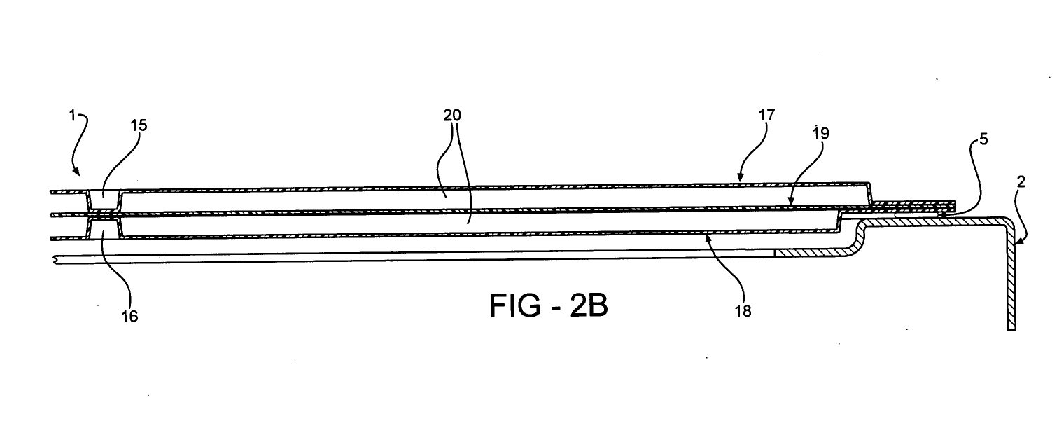

FIG. 2A is an elevational view of a multi-sheet barrier panel according to another embodiment of the present invention. The multi-sheet barrier panel 1 shown in FIG. 2A comprises three sheet members (described below) and is depicted as not having the engagement structures 3 shown in the embodiment of the invention of FIGS. 1A-1D. In this case, when the multi-sheet barrier panels do not include engagement structures that are formed therein, the multi-sheet barrier panels can be attached to vehicle door assemblies using conventional mechanical fasteners such as “christmas tree” fasteners, or engagement structures can be formed separately and attached to the outboard surface of the multi-sheet barrier panels. FIG. 2A depicts stepped channels 15 that are formed in the inboard surface of the multi-sheet barrier panel 1. A corresponding channel 16 is provided in the opposite side as discussed below. FIG. 2A depicts the opening 4 in exterior door panel 2 in broken lines as well as the bead of sealant/adhesive material 5.

FIG. 2B is a cross-sectional view of FIG. 2A taken along sectional lines II-II. As shown, the multi-sheet barrier panel of FIGS. 2A-2B includes an outer sheet 17, an inner sheet 18 and a middle sheet 19. As noted above, the channel 15 formed in the outer sheet 17 is aligned with a similar channel 16 formed in the inner sheet 18 as depicted in FIG. 2B. The bottoms of these channels 15, 16 are attached to middle sheet 19 by thermal welding, ultrasonic welding, chemical adhesives, mechanical fasteners, engaging or interlocking structures formed on the sheets, etc. According to one embodiment, the bottoms of these channels 15, 16 are attached to middle sheet 19 pressing the inner and outer sheets 18, 17 against the middle sheet 19 while they are partially molten or by applying both pressure and heat to the inner and outer sheets 18, 17 so that they fuse to the middle sheet 19.

The areas where the bottoms of the channels 15, 16 are fused or attached together corresponds to the discrete attachment areas 6 in the embodiment of the invention discussed above in reference to FIGS. 1A-1D. That is, the areas where the bottoms of the channels 15, 16 are fused or attached together stabilizes and strengthens the overall assembly of the multi-sheet barrier panel 1. As such, it can be understood that the configuration of the channels 15, 16, which are illustratively depicted as being stepped, can vary as desired. Moreover, two or more channel structures could be used that either intersect or are non-intersecting. Thus, for example, two or more parallel channels could be used, or a single spiral shaped channel, or two or more intersecting linear or non-linear channels could be used, in addition to other configurations.

As shown in FIG. 2B the outer and inner sheets 17, 18 are spaced apart from the middle sheet 19 so that there are spaces 20 therebetween. These spaces 20 provide an acoustic and/or thermal insulation barrier and can be either hollow or can contain acoustic and/or thermal insulation materials such as noise absorbing materials or materials with low thermal conductivity.

As shown in FIG. 2B the edges of the inner and outer sheets 18, 17 are sealed against the middle sheet 19. FIG. 2B also depicts a sealant/adhesive bead 5 that is similar to the sealant/adhesive bead 5 of FIG. 1C.

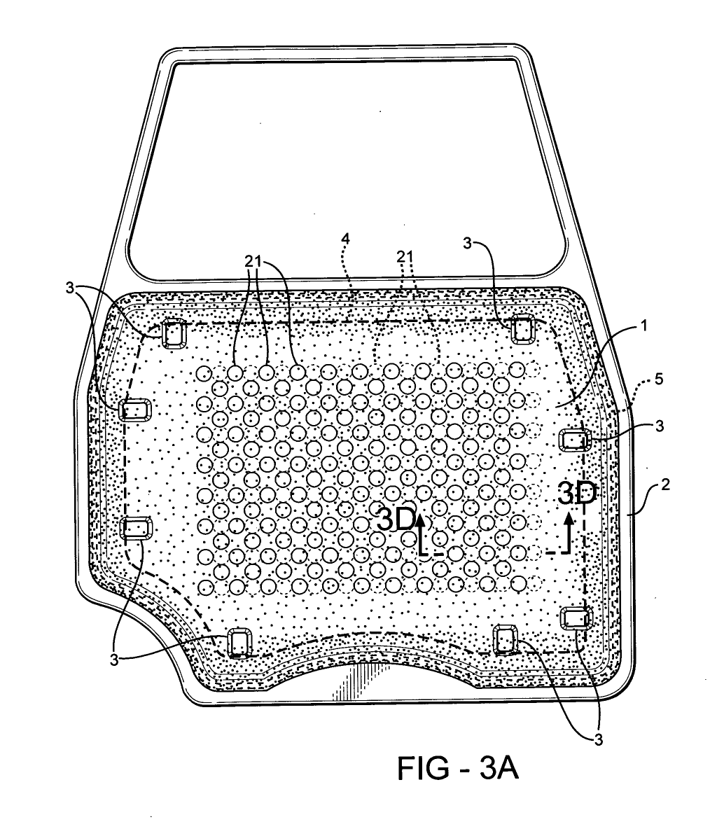

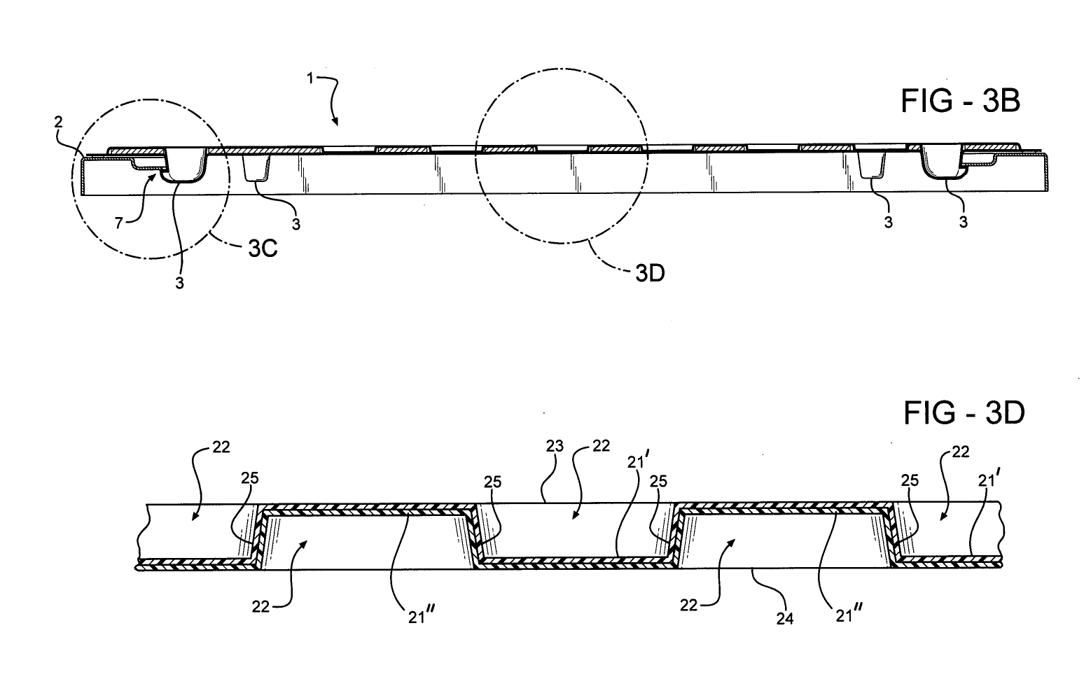

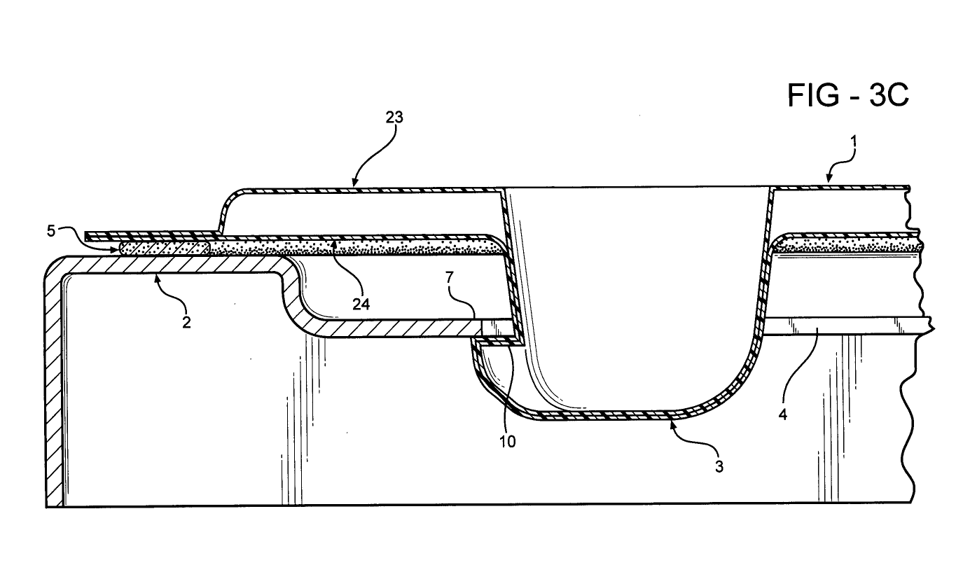

FIG. 3A is an elevational view of a multi-sheet barrier panel according to another embodiment of the present invention. The multi-sheet barrier panel is generally identified by reference numeral 1 and is depicted as being attached to an exterior door panel 2. The multi-sheet barrier panel 1 includes a plurality of engaging structures 3 that are spaced apart around the exterior edges of the multi-sheet barrier panel 2. As shown in broken lines, the door panel 2 includes an opening 4 into which the engaging structures 3 are received so as to align the multi-sheet barrier panel 1 with the exterior door panel 2 and secure the multi-sheet barrier panel 1 to the exterior door panel 2. Also shown in broken lines is a sealing element 5 that extends along the periphery of the multi-sheet barrier panel 1 so as to be positioned between the multi-sheet barrier panel 1 and the exterior door panel 2. The sealing element 5 can comprises any conventional sealant/adhesive material that is applied as a bead on the multi-sheet barrier panel 1 or a compressible sealing element that can be molded into the outboard surface of the outer most sheet of the multi-sheet assembly.

The multi-sheet barrier panel 1 is provided with a plurality of discrete attachment areas 21 at which the separate sheets of the multi-sheet barrier panel 1 are attached to one another. In the embodiment of the invention show in FIGS. 3A-3D the discrete attachment areas 21 are defined by a plurality of depressions or depressed areas 22 which are depicted in FIG. 3A as having circular configurations and be immediately adjacent to one another. The pattern or array of depressed areas 22 is shown as extending throughout the central portion of the multi-sheet barrier panel 1.

FIG. 3B is a cross-sectional view of FIG. 3A taken along sectional lines II-II. FIG. 3B best shows the manner in which the engaging structures 3 extend into the opening 4 provide in the inboard side of the exterior door panel 2 so as to engage the edge 7 of the opening 4. As can be understood from FIGS. 3A and 3B the number and alignment of the engaging structures 3 can be varied as desired to accommodate a given door assembly, taking into consideration size, shape, etc. From the cross-sectional view the discrete attachment areas 21 formed in the multi-sheet barrier panel 1 are seen as providing structures (side walls) that strengthen the overall structure of the multi-sheet barrier panels 1.

FIG. 3C is an enlarged view of the encircled portion “C” of the door assembly illustrated in FIG. 3B. As can be seen best in FIG. 3C, the multi-sheet barrier panel 1 comprises two sheets, including an outer sheet 23 and an inner sheet 24. In general, the outer sheet 23 and inner sheet 24 are spaced apart from one another, except at the discrete attachment areas 21 and where the engagement structures 3 are formed. As shown in FIG. 3C, the engagement structure 3 includes a molded under-cut or overhanging edge 10 (shown upside down) that engages the peripheral edge 7 of the opening 4 formed in the exterior door panel 2. Having the engagement structures 3 formed by each of the inner and outer sheet 24, 23 as shown in FIG. 3C adds strength to the engagement structures 3. As shown in FIG. 3C the outer sheet 23 is not coextensive with the inner sheet 24 which extends outward over sealant/adhesive bead 5 to compress the same. In alternative embodiments, the outer sheet 23 and inner sheet 24 can be coextensive.

FIG. 3D is an enlarged view of the encircled portion “D” of the door assembly illustrated in FIG. 3B. FIG. 3D depicts adjacent attachment areas 21′ and 21″ that alternate on either side of the multi-sheet barrier panel. FIG. 3D depicts the inner and outer sheets 24, 23 as being fused together at the discrete attachment areas 21′, 21″. Such fusion can be accomplished by pressing the inner and outer sheets 24, 23 together while they are partially molten or by applying both pressure and heat to the inner and outer sheets 24, 23 at the discrete attachment areas 21′, 21.″ The side walls 25 of the depressions 22 add to the structural strength of the overall assembly.

As noted above, the depressed areas 22 depicted in FIG. 3A as having circular configurations and be immediately adjacent to one another. Having the depressed areas 22 immediately adjacent one another adds strength to the multi-sheet barrier panel 1 since the side walls 25 of the depressed areas 22 are connected or linked to one another, with common portions of the side walls 25 being shared by immediately adjacent ones of the depressed areas 22. In other embodiments, the depressed areas 22 can be spaced apart from one another or have shapes other than the circular shape illustrated.

The space between the outer sheet 23 and inner sheet 24 that extends outward from the array of attachment areas 21 to the joined edges of the outer sheet 23 and inner sheet 24 functions as an acoustic and/or thermal insulation barrier can be hollow or can contain acoustic and/or thermal insulation materials such as noise absorbing materials or materials with low thermal conductivity. In alternative embodiments of the invention depicted in FIGS. 3A-3C, the attachment areas could be arranged to provide areas within the central portion of the multi-sheet barrier panel where the outer sheet 23 and inner sheet 24 are spaced apart and either hollow or provided with an insulation material as discussed herein. Similarly, in embodiments of the invention discussed above that include intersecting channels, the space between the various sheets can be separated into some discrete portions

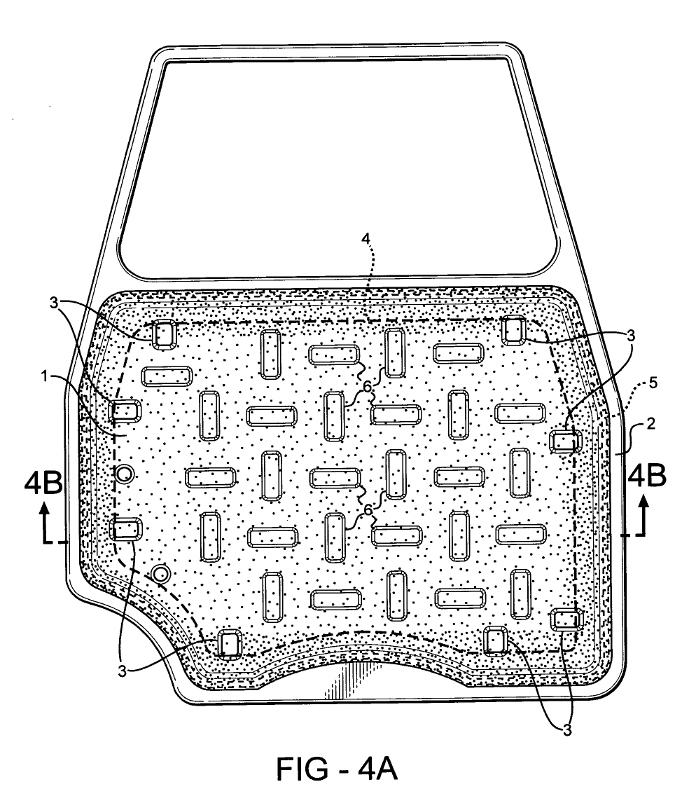

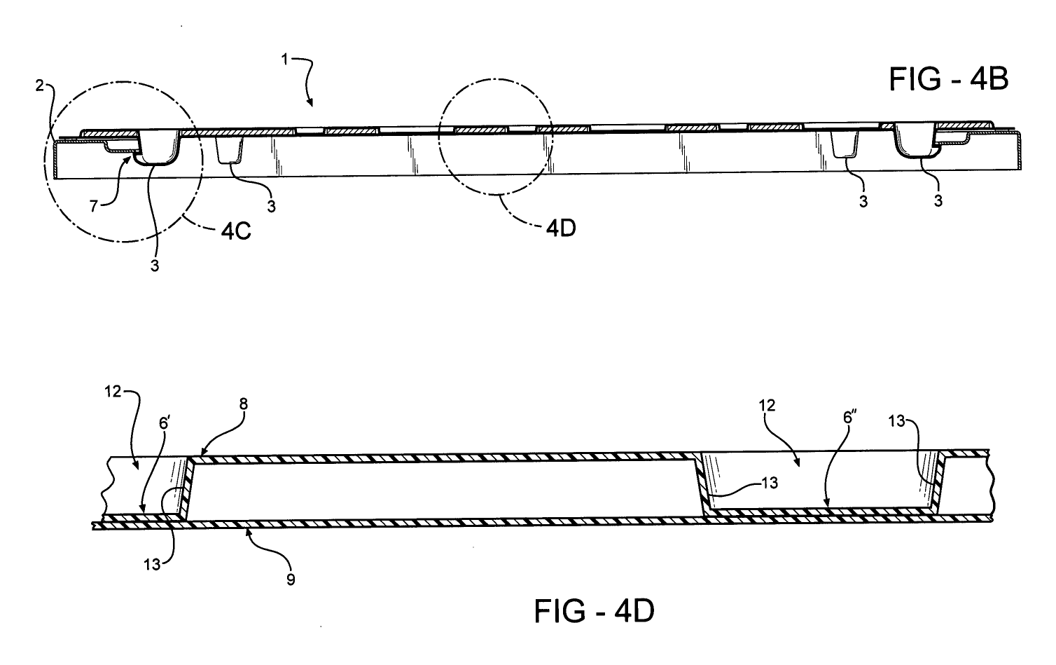

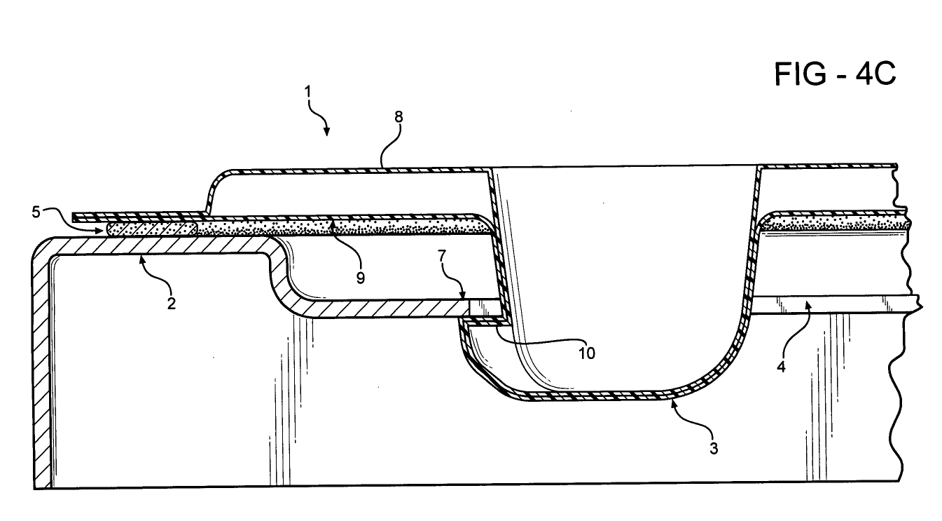

FIG. 4A is an elevational view of a multi-sheet barrier panel according to another embodiment of the present invention. FIG. 4B is a cross-sectional view of FIG. 4A taken along sectional lines II-II. FIG. 4C is an enlarged view of the encircled portion “C” of the door assembly illustrated in FIG. 4B. FIG. 4D is an enlarged view of the encircled portion “D” of the door assembly illustrated in FIG. 4B.

The embodiment of the invention depicted in FIGS. 4A-4D is structurally the same as that depicted in FIGS. 1A-1D, accordingly, the same elements are identified with the same reference numerals in FIGS. 4A-4C and 1A-1C and reference is made to the description of FIGS. 1A-1C above.

The difference between the embodiment of the invention depicted in FIGS. 4A-4D and that depicted in FIGS. 1A-1D is that the space between the outer and inner sheets 8, 9 does not contain any insulating material in the embodiment of the invention depicted in FIGS. 4A-4C.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A barrier liner for a vehicle door assembly having a door panel and an inner trim panel, said barrier liner comprising:
at least two sheet members, including a first and second sheet which have opposing surfaces that are spaced apart from each other; and
discrete attachment areas at which the first and second sheet are attached to one another, said discrete attachment areas including side walls that extent between the first and second sheets, said discrete attachment areas extending across a central portion of the barrier liner.

2. A barrier liner for a vehicle door assembly according to claim 1, further comprising at least one of an acoustic and a thermal insulation material provided between the first and second sheet except at the discrete attachment areas.

3. A barrier liner for a vehicle door assembly according to claim 1, wherein the discrete attachment areas comprise areas at which the first and second sheet are fused together.

4. A barrier liner for a vehicle door assembly according to claim 1, wherein the discrete attachment areas comprise a plurality of discrete attachment areas that are arranged in a regular pattern.

5. A barrier liner for a vehicle door assembly according to claim 1, the discrete attachment areas comprise depressed areas that are formed in at least one of the first and second sheets.

6. A barrier liner for a vehicle door assembly according to claim 5, adjacent ones of the discrete attachment areas share a common sidewall.

7. A barrier liner for a vehicle door assembly according to claim 5, wherein the attachment areas comprises at least a channel segment that is formed in one of the first and second sheets.

8. A barrier liner for a vehicle door assembly according to claim 1, wherein the barrier liner includes a plurality of engagement structures that are configured to attach the barrier panel to the door panel.

9. A barrier liner for a vehicle door assembly according to claim 1, wherein the at least two sheet members, includes a first and second outer sheets and a third middle sheet that is positioned between the first and second outer sheets, the middle sheet being spaced apart from each of the outer sheets;
first discrete attachment areas at which the first outer sheet and the third middle sheet are attached to one another; and
second discrete attachment areas at which the second outer sheet and the third middle sheet are attached to one another,
the first discrete attachment areas including side walls that extent between the first outer sheet and the third middle sheet,
the second discrete attachment areas including side walls that extent between the second outer sheet and the third middle sheet,
the first and second discrete attachment areas extending across a central portion of the barrier liner.

10. A barrier liner for a vehicle door assembly according to claim 9, wherein the first and second discrete attachment areas are aligned on opposite sides of the barrier liner.

11. A barrier liner for a vehicle door assembly according to claim 9, wherein at least one of an acoustic and a thermal insulation material provided between at least one of the first outer sheet and the third middle sheet and the second outer sheet and the third middle sheet except at the discrete attachment areas.

12. A barrier liner for a vehicle door assembly according to claim 1, wherein at least one of the first and second sheets comprises a water-impermeable material.

13. A barrier liner for a vehicle door assembly according to claim 1, wherein the barrier liner includes a sealing element that extends along the periphery of one side therefore for sealing against the door panel.

14. A barrier liner for a vehicle door assembly according to claim 12, wherein the sealing element comprises a bead of a sealant/adhesive material.

15. A method of making a multi-sheet barrier panel for a vehicle door assembly having a door panel and an inner trim panel, said method comprising:
providing least two sheet members, including a first and second sheet;
forming discrete depressions in at least one of the first and second sheet, said discrete depressions have bottoms;
superimposing the first and second sheets together so that the bottoms of the discrete depressions formed in one of the first and second sheets contacts the other of the first and second sheets at discrete contact areas; and
attaching the first and second sheets together at the discrete contact areas.

16. A method of making a multi-sheet barrier panel according to claim 15, wherein the first and second sheets are fused together at the discrete contact areas.

17. A method of making a multi-sheet barrier panel according to claim 15, wherein at least one of an acoustic and a thermal insulation material is provided in a space defined between the first and second sheets

18. A method of making a multi-sheet barrier panel according to claim 15, wherein:
the step of providing at least two sheets comprises providing first and second outer sheets and a third middle sheet;
the step of forming discrete depressions comprises forming discrete depressions in at least one of the first and second outer sheets, one of the first and second outer sheets and the third middle sheet or in the middle sheet;
the step of superimposing the sheets together comprises superimposing the first and second outer sheets and the third middle sheets together so that the bottoms of the discrete depressions formed in one of the sheets contacts an adjacent sheet at discrete contact areas; and
the step of attaching comprises attaching the first and second outer sheets and the third middle sheet together at the discrete contact areas.

19. A method of making a multi-sheet barrier panel according to claim 18, wherein at least one of an acoustic and a thermal insulation material is provided in a space defined between at least one of the first outer sheet and the third middle sheet and the second outer sheet and the third middle sheet.

20. A method of making a multi-sheet barrier panel according to claim 15, wherein engagement structures that are configured to attach the barrier panel to the door panel are provided on the barrier panel.
